(19) United States
(12) Patent Application Publication
(10) Pub. No.: US 2024/0263035 A1
(43) Pub. Date: Aug. 8, 2024

(54) HYBRID PAINT COMPOSITIONS INCLUDING INORGANIC AND ORGANIC BINDERS

(71) Applicant: Arkema Inc., King of Prussia, PA (US)

(72) Inventors: Lei YANG, King of Prussia, PA (US); Wenjun WU, King of Prussia, PA (US); Jeffrey A. SCHNEIDER, King of Prussia, PA (US)

(21) Appl. No.: 18/290,324

(22) PCT Filed: May 24, 2022
(86) PCT No.: PCT/US2022/030696

§ 371 Date: Nov. 13, 2023

Related U.S. Application Data
(60) Provisional application No. 63/193,657, filed on May 27, 2021.
(60) Provisional application No. 63/304,717, filed on Jan. 31, 2022.
(60) Provisional application No. 63/304,720, filed on Jan. 31, 2022.

(51) Int. Cl. C09D 133/08; C08F 220/18; C08K 3/22; C08K 3/34; C08K 5/5419; C08L 1/02; C09D 7/20; C09D 7/43

(52) U.S. Cl. CPC C09D 133/08; C08F 220/1804; C08K 3/22; C08K 3/34; C08K 5/5419; C08L 1/02; C09D 7/20; C09D 7/43; C08K 2003/2241

(57) ABSTRACT

An aqueous composition for coating cementitious or masonry substrates is provided. When dried, the coating composition has high gloss and low dirt pick-up. The composition includes at least one emulsified polymeric binder; at least one water-soluble silicate; at least one alkyl siliconate; at least one pigment, optionally at least one filler; optionally at least one paint additive; and water. The pigment volume concentration (PVC) of the aqueous composition is 40 weight % or less.

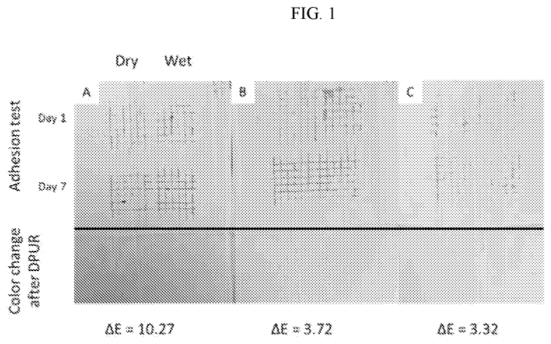

### FIELD OF THE INVENTION

The invention relates to one-part waterborne (aqueous) pigmented coating compositions of latex, silicate and siliconate. The compositions are useful as paints on cementitious and masonry substrates and provide glossy, dirt-resistant surfaces.

### BACKGROUND

One-part water based coatings have been often used to protect cementitious and masonry substrates, such as concrete substrates, to improve the durability and aesthetics of such substrates. Among many coating properties, high gloss is often desired for floor coating applications, and dirt pick up resistance is needed for exterior masonry coating applications.

EP 3712216 discloses N, N, N′, N′-tetrakis (2-hydroxypropyl) hexane-1,6-diamine as a viscosity stabilizer in aqueous coating compositions containing silicate and at least one organic polymeric binder.

EP 2081998 discloses nitrogen containing compounds having molecular weight from 120 to 10,000 Daltons combined with alkyl siliconates as viscosity stabilizers for coating compositions containing water, fillers and/or pigments as well as low levels of a binder.

EP 1297079 discloses a preservative-free emulsion paint containing 4-15 weight % of a polymer dispersion; 10-55 weight % of pigment and/or filler; a maximum of 2 weight % of water glass as an additive; and water to make up to 100 weight %.

U.S. Pat. No. 10,322,485 discloses a method for treating a flooring surface. The method includes applying a composition that includes a silicate to the flooring surface and, while the composition is present on the surface, polishing or burnishing the surface. The silicate may be a lithium polysilicate and/or a colloidal silica.

U.S. Pat. No. 9,228,094 discloses a composition for protecting a surface of an inorganic substrate, such as concrete, terrazzo, or ceramic tile, including a silicate (i.e., an alkali metal polysilicate or a colloidal silica), a siliconate (e.g., a metal siliconate, such as an alkali metal methyl siliconate, etc.), acrylic latex, a silane coupling agent, and a solvent, such as ethylene glycol monobutyl ether.

US 2021/0269653 discloses a biocide-free pigmented paint composition including 5 to 50 weight % polymer dispersion polymerized by 2-ethyl hexyl acrylate, butyl acrylate, and one or more vinylaromatics, 0.1 to 5 weight % alkali metal silicate and/or siliconate, 20 to 70 weight % inorganic fillers, 0 to 30 weight % inorganic pigments, with pigment volume concentration (PVC) ranging from 60 to 90. The polymer dispersion includes 2-ethyl hexyl acrylate, butyl acrylate, and one or more vinylaromatics (preferably styrene) as polymerized monomers. The filler content has to be greater than 20 weight %.

US 2021/0230431 discloses an emulsion composition including an acrylic polymer, a metal silicate, and water. The disclosed hybrid paints that contain both latex polymers (organic binder) and water-soluble alkali metal silicates (inorganic binder) are intended for improved adhesion to cementitious and masonry substrates, such as concrete substrates.

US 2019/0177558 discloses dialkylglucosamines as stabilizers for coating compositions that comprise both latex and silicate.

WO 2020/180616 discloses a water-based coating composition containing a pigment, a polymeric dispersion and a hydrolysable silane. Optionally, 0.1 to 4 weight %, of either or both of silicates and siliconates may be included.

WO 2020/002102 discloses an aqueous emulsion paint including a) 5 to 50% by weight of an aqueous polymer dispersion having a solids content in the range from 40 to 60% by weight; b) 0.1 to 10% by weight of alkali alkyl siliconate and/or water-soluble silicate; c) 20 to 70% by weight of inorganic fillers; d) 0 to 30% by weight of at least one inorganic pigment; and e) 0.1 to 10% by weight of conventional auxiliaries.

It remains challenging, however, to improve gloss in such pigmented hybrid paints that contain, for example, both latex polymers and silicates, even when the paint has low pigment volume concentration (hereinafter “PVC”) that should provide high gloss. Without being bound to any theory, the low gloss may be due to the presence of silicates and the like. For example, high gloss coatings which provide shiny surfaces are often desired for floor coatings (e.g., garage and basement flooring) applications. In addition, dirt pick up resistance is often required for exterior coatings (e.g., patio and porch coatings), because the ability to resist dirt and prevent color change is needed to ensure the attractiveness of the coatings upon exterior exposure.

Therefore, there remains a need to improve the gloss and dirt pick up resistance of hybrid paints with low pigment volume concentration/PVC, such as those that contain both latex polymers and silicates, intended for cementitious and masonry coating applications.

### SUMMARY

Surprisingly, the inventors have solved the problem of low gloss and dirt pick up resistance for low PVC latex-silicate based coating materials. The compositions of the invention comprise, inter alia, water, emulsified polymeric binder, water soluble silicate, pigment and alkyl siliconate. The addition of water-soluble alkyl siliconate to the pigmented hybrid paint formulation comprising latex polymers and inorganic silicates surprisingly improved the gloss development and dirt pickup resistance of the dried coatings.

The aqueous compositions of the invention provide a glossy coating after drying and are storage stable. They also are a one-part composition, thereby removing the need to combine one or more compositions/parts into a single composition prior to coating, making application easier and more efficient. Furthermore, the improved dirt pick up resistance and good adhesion provided by the inventive latex-silicate-siliconate hybrid paint increases the service life of masonry and cementitious coatings, thus improving the resilience of masonry and cementitious-based infrastructure.

An aqueous composition is provided. The aqueous composition comprises, consists of, or consists essentially of the following components, based on the total wet weight of the composition.
a) 5-50 weight %, preferably 10-40 weight %, more preferably 10-30 weight % of at least one emulsified polymeric binder;
b) 2-10 weight %, preferably 2-8 weight %, more preferably 3-7 weight % of at least one water-soluble silicate;
c) 0.01-5 weight %, preferably 0.1 to 3 weight %, more preferably 0.2 to 1 weight % of at least one alkyl siliconate;
d) at least one pigment,
e) optionally at least one filler;
f) optionally at least one additive; and
g) water.

The aqueous composition has a pigment volume concentration (PVC) of 40 weight % or less, preferably 35 weight % or less, more preferably 30 weight % or less. The PVC is defined as:

$$\frac{dry volume of ( pigment + filler )}{dry volume of ( pigment + filler + water soluble silicate + polymeric binder )} \times 100.$$

According to certain embodiments, the aqueous composition is a one-part composition.

### BRIEF DESCRIPTION OF THE FIGURE

The FIGURE shows the adhesion and dirt pick-up resistance of certain embodiments of the invention.

### DETAILED DESCRIPTION

As used herein, all percentages are percentage by weight unless stated otherwise.

“Cementitious substrate” as used herein means a cured or uncured surface comprising one or more minerals which hardens when exposed to water including, but not limited to, clay, calcium, calcined lime, sand, gravel, a powder of alumina, silica, silicon, iron oxide, magnesia and combinations thereof. “Cementitious substrate” as used herein is interchangeable with cement, concrete, and/or mortar. As used herein, a “cured” cementitious substrate is one that has been exposed to water and is at least partially hydrated and/or hardened. “Masonry substrate” as used herein means a substrate that comprises individual units, which are laid in and bound together by mortar. Common materials of masonry construction include brick, building stone such as marble, granite, and limestone, cast stone, concrete block, glass block, and adobe. Mortar includes a mixture of cement, lime, and sand.

### a) Emulsified Polymeric Binder

The pigmented aqueous composition comprises, consists of, or consists essentially of 5 to 50 weight %, preferably 10-40 weight %, more preferably 10-30 weight % of an emulsified polymeric binder a), based on the total wet weight of the composition. The particle size of the emulsified polymeric binder a) may be from 50 to 500 nm, preferably from 50 to 400 nm, more preferably from 50 to 300 nm, or most preferably from 50 to 250 nm, according to certain embodiments of the invention. Particle size refers to volume average particle size measured using dynamic light scattering using a Nanotrac UPA 150 manufactured by Microtrac.

The polymeric binder a) may comprise, as a polymerized monomer, from 0.1 to 99.9, preferably 10 to 90, more preferably, 20 to 80 weight % of an alkyl (meth)acrylate based on the dry weight of the polymeric binder a). The polymeric binder a) may comprise at least 0.2, 0.3, 0.5, 0.6, 0.7, 0.8, 0.9, 1, 3, 5, 10 weight %, 15, 20, 25, 30, 35, 40, 45, 50, 55, 60, 65, 70, 75, 80, 90, 95, or 99 weight % of an alkyl (meth)acrylate, based on the dry weight of binder a). The polymeric binder a) may comprise at most 99.9, 99.5, 95, 90, 80, 75, 70, 65, 60, 55, 50, 45, 40, 35, 30, 25, 20, 15, 10, 5, 3, 1, 0.9, 0.8, 0.7, 0.6, 0.5, 0.3, or 0.2 weight % of an alkyl (meth)acrylate, based on the dry weight of binder a).

Non-limiting examples of suitable alkyl (meth)acrylates are alkyl esters of (meth) acrylic acid, for example. Non-limiting examples include methyl (meth)acrylate, ethyl (meth)acrylate, butyl (meth)acrylate, cyclohexyl (meth)acrylate, allyl methacrylate, 2-ethylhexyl acrylate; iso-octyl methacrylate and iso-octyl acrylate, lauryl acrylate and lauryl methacrylate, stearyl acrylate and stearyl methacrylate, isobornyl acrylate and isobornyl methacrylate monomers.

The polymeric binder a) may comprise, as a polymerized monomer, from 0 to 10 weight %, preferably 0.05 to 5 weight %, and more preferably at least 0.1 to 2 weight % of (meth)acrylamide or derivatives thereof based on the dry weight of the polymeric binder a). For example, the polymeric binder a) may comprise at least 0, 0.1, 0.5, 1.0, 1.2, 2, 2.5, 3, 3.5, 4, 4.5, 5, 5.5, 6, 6.5, 7, 7.5, 8, 8.5, 9, or 9.5 weight percent of (meth)acrylamide or derivatives thereof based on the dry weight of the polymeric binder a). The polymeric binder a) may comprise at most 10, 9.5, 9, 8.5, 8, 7.5, 7, 6.5, 6, 5.5, 5, 4.5, 4, 3.5, 3, 2.5, 2, 1.5, 1, 0.5, 0.2 or at least 0.1 weight percent of (meth)acrylamide or derivatives thereof based on the dry weight of the polymeric binder a). Combinations of (meth)acrylamide and derivatives thereof are also contemplated.

Suitable (meth)acrylamide derivatives may include, but are not limited to N-(hydroxymethyl)acrylamide, N-(hydroxyethyl) acrylamide, 2-hydroxypropyl methacrylamide, methacrylamide poly(ethylene glycol) amine hydrochloride, N-tris(hydroxymethyl)methylacrylamide, (4-hydroxyphenyl)methacrylamide, 2-aminoethylmethacrylamide hydrochloride, N-phenylacrylamide, 2-acrylamido-2-methylpropane sulfonic acid and its salts, and mixtures thereof

The polymeric binder a) may comprise, as a polymerized monomer, from 0 to 10 weight %, preferably 0.05 to 5 weight %, and more preferably at least 0.1 to 2 weight % of (meth)acrylic acid based on the dry weight of the polymeric binder a). For example, the polymeric binder may comprise at least 0, 0.1, 0.5, 1.0, 1.2, 2, 2.5, 3, 3.5, 4, 4.5, 5, 5.5, 6, 6.5, 7, 7.5, 8, 8.5, 9, or 9.5 weight percent of (meth)acrylic acid. The polymeric binder a) may comprise at most 10, 9.5, 9, 8.5, 8, 7.5, 7, 6.5, 6, 5.5, 5, 4.5, 4, 3.5, 3, 2.5, 2, 1.5, 1, 0.5, 0.1, or at least 0.1 weight percent of (meth)acrylic acid based on the dry weight of the polymeric binder a).

The binder a) may comprise, as a polymerized monomer, from 0 to 90 weight %, preferably from 10 to 90 weight %, more preferably from 20 to 80 weight % of a vinyl aromatic monomer based on the dry weight of the polymeric binder a). Non-limiting examples include styrene, alkyl styrenes and derivatives thereof, such as alpha methyl styrene. The vinyl aromatic monomer may be present in the in the polymeric binder a) at a level of at least 0, 0.1, 0.2, 0.5, 0.6, 0.7, 0.8, 0.9, 1, 3, 5, 10, 15, 20, 25, 30, 35, 40, 45, 50, 55, 60, 65, 70, 75, 80, 85, 90, 95, or 99 weight %, based on the dry weight of binder a). The vinyl aromatic monomer may be present in the polymeric binder at a level of at most 99.5, 99, 95, 90, 85, 80, 75, 70, 65, 60, 55, 50, 45, 40, 35, 30, 25, 20, 15, 10, 5, 3, 1, 0.9, 0.8, 0.7, 0.6, 0.5, 0.2, 0.1, or 0 weight %, based on the dry weight of the polymeric binder a).

Other suitable monomers that are capable of free radical polymerization may be included in the binder a) at levels from about 0 to 99.5 weight %. For example these other suitable monomers may be included in the polymeric binder a) at about 0, 0.2, 0.3, 0.5, 0.6, 0.7, 0.8, 0.9, 1, 3, 5, 10, 15, 20, 25, 30, 35, 40, 45, 50, 55, 60, 65, 70, 75, 80, 90, 95, or 99 weight %, based on the dry weight of binder a). These other suitable monomers may be present in the polymeric binder a) at a level of at least 0, 0.1, 0.2, 0.5, 0.6, 0.7, 0.8, 0.9, 1, 3, 5, 10, 15, 20, 25, 30, 35, 40, 45, 50, 55, 60, 65, 70, 75, 80, 85, 90, 95, or 99 weight %, based on the dry weight of binder a). These other suitable monomers may be present in the polymeric binder at a level of at most 99.5, 99, 95, 90, 85, 80, 75, 70, 65, 60, 55, 50, 45, 40, 35, 30, 25, 20, 15, 10, 5, 3, 1, 0.9, 0.8, 0.7, 0.6, 0.5, 0.2, 0.1, or 0 weight %, based on the dry weight of the polymeric binder a). According to an embodiment, these monomers may comprise, consist of, or consist essentially of at least one of vinyl monomer, mono-ethylenically unsaturated carboxylic acid monomer, phosphorous-containing monomer, sulfur-containing monomer, silane co-monomers, and mixtures thereof. These other suitable monomers may include various carboxylic acids such as itaconic acid, and esters thereof, various esters of versatic acid, methoxyethyl acrylate and methoxyethyl methacrylate, 2-ethoxy ethyl acrylate and 2-ethoxyethyl methacrylate, and combinations thereof. Also suitable as optional monomers are acrylonitrile; vinyl cyanides; vinylpyrrolidone; polypropylene glycol mono(meth)acrylate or polyethylene glycol mono(meth)acrylate; phosphorous-based monomers including but are not limited to phosphoalkyl (meth)acrylates or acrylates, phosphoalkyl (meth)acrylamides or acrylamides, phosphoalkyl crotonates, phosphoalkyl maleates, phosphoalkyl fumarates, phosphodialkyl (meth)acrylates, phosphodialkyl crotonates, vinyl phosphates and (meth)allyl phosphate, phosphate esters of polypropylene glycol mono(meth)acrylate or polyethylene glycol mono(meth)acrylate, polyoxyethylene allyl ether phosphate, vinyl phosphonic acid. Suitable sulfur-based monomers include, but are not limited to, vinyl- and allyl-sulfonic or sulfuric acids, sulfoethyl (meth)acrylate, aryl-sulfonic or sulfuric acids, (meth)acrylamidoethane-sulfonic or sulfuric acids, methacrylamido-2-methyl propane-sulfonic or sulfuric acids, and the alkali metal salts of sulfonic and sulfuric acids. Suitable optional silane co-monomers include, but are not limited to methacryloxypropyl trimethoxysilane, methacryloxypropyl triethoxysilane, methacryloxypropyl tripropoxysilane, vinyltriacetoxysilane, vinyltrimethoxysilane, and vinyltriethoxysilane. The more preferred silane co-monomers are methacryloxypropyl trimethoxysilane and vinyltrimethoxysilane.

Crosslinkable co-monomers may also optionally be present in polymeric binder a). These crosslinkable co-monomers may be of two different types. The first type is crosslinkable co-monomers that include two or more sites of ethylenic unsaturation such that the crosslinks are formed during polymerization of the polymeric binder a). The second type of crosslinkable co-monomer are those that include, in addition to an ethylenic unsaturation ((meth)acrylate, allyl or vinyl functional groups), at least one moiety that is capable of reacting with a separate crosslinking compound that may be included in the one-part aqueous composition to form a crosslink.

Suitable crosslinkable co-monomers with two or more sites of ethylenic unsaturation include, but are not limited to, ethylene glycol dimethacrylate, diethylene glycol dimethacrylate, trimethylolpropane trimethacrylate, 1,3-butyleneglycol dimethacrylate, and 1,4-butyleneglycol dimethacrylate, hexanediol dimethacrylate, divinyl benzene, diallyl phthalate, and the like.

Crosslinkable co-monomers that are capable of reacting with a separate crosslinking agent that may be included in the one-part aqueous composition may be selected from, for example, acetoacetate co-monomers containing (meth)acrylate, allyl or vinyl functional groups including but not limited to acetoacetate moieties such as: 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate and combinations thereof. Also suitable are co-monomers containing a keto group such as diacetone acrylamide. The more preferred crosslinkable monomers are acetoacetoxyethyl methacrylate and diacetone acrylamide. Water-soluble crosslinking agents that can react with certain moieties of these second type of crosslinkable co-monomers may also optionally be included in the one-part aqueous composition. These water soluble crosslinking agents effect post crosslinking during film formation and drying by reacting with the crosslinkable moieties on the second type of crosslinkable co-monomers. For example such crosslinking agents containing at least two hydrazine and/or hydrazide groups may be included in certain embodiments of the one-part aqueous composition. Preferred such separate crosslinking agents are water soluble. Non-limiting examples include oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Adipic acid dihydrazide (ADH) is a preferred water-soluble cross-linking agent for use in the compositions herein, especially those produced from monomer compositions containing diacetone acrylamide (DAAM). Other suitable water-soluble cross-linking agents are compounds which contain at least two amine functional moieties such as ethylene diamine and hexamethylene diamine. Such cross-linking agents are preferred in combination with polymers comprising 1,3-dicarbonyl groups as the crosslinkable moiety, such as acetoacetoxyethyl methacrylate (AAEM). These separate crosslinking agents may be present in the one-part aqueous composition at from 0.01 to 10 weight % of the aqueous one-part composition. For example, the separate crosslinking agents may be present at from 0.1-8 weight %, or from 1 to 5 weight % based on the total weight of the one-part aqueous composition.

These optional crosslinking co-monomers of either type, if present, may be included in the polymeric binder a) at levels from about 0.1 to 99.50 weight %, or at about 0.2, 0.3, 0.5, 0.6, 0.7, 0.8, 0.9, 1, 3, 5, 10, 15, 20, 25, 30, 35, 40, 45, 50, 55, 60, 65, 70, 75, 80, 90, 95, or 99 weight %, based on the dry weight of binder a). For example, the crosslinking co-monomers may be present in the polymeric binder a) at a level of at least 0.1, 0.2, 0.5, 0.6, 0.7, 0.8, 0.9, 1, 3, 5, 10, 15, 20, 25, 30, 35, 40, 45, 50, 55, 60, 65, 70, 75, 80, 85, 90, 95, or 99 weight %, based on the dry weight of binder a). The crosslinking co-monomers may be present in the polymeric binder a) at a level of at most 99.5, 99, 95, 90, 85, 80, 75, 70, 65, 60, 55, 50, 45, 40, 35, 30, 25, 20, 15, 10, 5, 3, 1, 0.9, 0.8, 0.7, 0.6, 0.5, 0.1, or 0.2 weight %, based on the dry weight of the polymeric binder a)

Emulsion polymers and monomers useful to prepare polymeric emulsions or dispersions are known in the art (see, e.g., “Emulsion Polymerization: Theory and Practice” by D. C. Blackley published by Wiley in 1975, “Emulsion Polymerization” by F. A. Bovey et al. published by Interscience Publishers in 1965, and “Emulsion Polymerization and Emulsion Polymers” by P. A. Lovell et al. published by Wiley Science in 1997).

The emulsified polymeric binder might further comprise non-polymerizable additives. The non-polymerizable additives can be added during the polymerization or after polymerization. Non-limiting examples of suitable non-polymerizable additives include silanes, epoxysilanes, oligomeric epoxysilanes, aminosilanes, coalescents, rheology control additives, additional polymers, surfactants, plasticizers, defoamers, thickeners, biocides, solvents, rheology modifiers, wetting or spreading agents, conductive additives, thermal insulating fillers, adhesion promoters, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, humectants, insecticides, lubricants, odorants, oils, waxes or anti-slip aids, soil repellants, and/or stain resistant agents.

### b) Water-Soluble Silicate

The aqueous composition includes 2 to 10 weight %, preferably 2 to 8 weight %, more preferably 3 to 7 weight % of a water-soluble silicate. For example, the aqueous composition may include at least 2, 2.5, 3, 3.5, 4, 4.5, 5, 5.5, 6, 6.5, 7, 7.5, 8, 8.5, 9, or 9.5 weight percent of a water-soluble silicate based on the wet weight of the aqueous composition. The aqueous composition a) may include at most 10, 9.5, 9, 8.5, 8, 7.5, 7, 6.5, 6, 5.5, 5, 4.5, 4, 3.5, 3, 2.5, 2, or at least 1 weight percent of water-soluble silicate based on the wet weight of the pigmented aqueous coating composition.

As used herein, “silicate” refers to any inorganic salt silicate, including preferably compounds having the formula M₂ₓSi_{y}O_{2y+x}, M being alkali metal ions such as Li+, Na+, K+Rb+, or ammonium ion NH4+. Non-limiting examples of suitable water-soluble silicates include inorganic silicate salts, sodium silicate, potassium silicate, lithium silicate, rubidium silicate, ammonium silicate, orthosilicates, or mixtures thereof.

In one embodiment, the at least one silicate b) may comprise, consist of or consist essentially of at least one of sodium silicate, potassium silicate, lithium silicate, rubidium silicate, ammonium silicate, orthosilicates, inorganic silicate salts, or a mixture thereof. Potassium silicate, sodium silicate and lithium silicate are preferred. More preferred are potassium silicate and sodium silicate.

### c) Alkyl Siliconate

The coating composition comprises, consists of or consists essentially of from 0.01 to 5 weight %, preferably 0.1 to 3 weight %, more preferably 0.2 to 1 weight % of at least one alkyl siliconate c). The alkyl siliconate c) conforms to Formula (I):

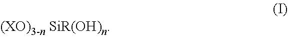

In Formula (I), X is an alkali metal; n is 0, 1, or 2; and R is an alkyl or aryl group. According to some embodiments, X comprises at least one of sodium, potassium, lithium, rubidium, cesium, or combinations thereof.

In Formula (I), R may comprise a C1-C8 alkyl group or an aryl group. According to some embodiments, R may comprise methyl, ethyl, n-propyl, iso-propyl, n-butyl, iso-butyl, tert-butyl, n-pentyl, iso-pentyl, tert-pentyl, neopentyl, phenyl, aryl, or cyclohexyl. According to another embodiment, R is methyl, X is potassium and n is 0. According to another embodiment, alkyl siliconate is potassium methyl siliconate.

### d) Pigment

The composition includes at least one pigment. As used herein, a pigment is a white or colored material that is completely or nearly insoluble in water and has the ability to impart color or hiding to the dried coating composition.

The composition includes from 5 to 40, preferably from 5 to 30, and more preferably from 5 to 25 weight percent of one or more pigments based on the weight of pigmented aqueous coating composition.

Non-limiting examples of suitable pigments include inorganic white pigments such as titanium dioxide, preferably in the rutile form, barium sulfate, zinc oxide, zinc sulfide, basic lead carbonate, antimony trioxide, lithopone (zinc sulfide and barium sulfate); as well as cadmium pigments such as cadmium yellow, cadmium red, cadmium green, cadmium orange, cadmium sulfoselenide; chromium pigments such as chrome yellow and chrome green (viridian); cobalt pigments such as cobalt violet, cobalt blue, cerulean blue, aureolin (cobalt yellow); copper pigments such as Azurite, Han purple, Han blue, Egyptian blue, Malachite, Paris green, Phthalocyanine Blue BN, Phthalocyanine Green G, verdigris; iron oxide pigments such as sanguine, caput mortuum, oxide red, red ochre, yellow ochre, Venetian red, Prussian blue, raw sienna, burnt sienna, raw umber, burnt umber; lead pigments such as lead white, cremnitz white, Naples yellow, red lead, lead-tin-yellow; manganese pigments such as manganese violet; mercury pigments such as vermilion; titanium pigments such as titanium yellow, titanium beige, titanium black; zinc pigments such as zinc white, zinc ferrite, zinc yellow; aluminum pigment such as aluminum powder; carbon pigments such as carbon black (including vine black, lamp black), ivory black (bone charcoal); ultramarine pigments (based on sulfur) such as ultramarine, ultramarine green shade.

### e) Filler

Filler as used herein is defined as an ingredient that does not provide color or hiding. If present, the filler may be present at from 0 to 20, preferably from 0 to 15, and more preferably from 0 to 10 weight percent of one or more fillers.

Non-limiting examples of fillers are alkaline earth metal carbonates such as calcium carbonate, clay minerals, aluminosilicates, such as kaolin, andalusite, kyanite, and sillimanite, alkaline earth metal sulfate such as calcium sulfate and barium sulfate, talc, aluminum stearate, diatomaceous earth, wollastonite, nephelene syenite, alumina, silica, and silicon oxide.

### f) Additives

The one-part composition may further comprise at least one additive. Non-limiting examples of suitable additives are those that are typically included in coating compositions including, for example, neutralizing agents such as ammonium hydroxide, sodium hydroxide, and potassium hydroxide, coalescents, leveling agents, dyes, emulsifiers, rheology control additives, additional polymers, colorants, dispersants or surfactants, plasticizers, defoamers, thickeners, stabilizers, viscosity stabilizers, biocides, solvents, rheology modifiers, wetting or spreading agents, conductive additives, thermal insulating fillers, adhesion promoters, anti-blocking agents, anti-cratering agents or anti-crawling agents, corrosion inhibitors, anti-static agents, flame retardants, optical brighteners, UV absorbers or other light stabilizers, chelating agents, cross-linking agents, flattening agents, humectants, insecticides, lubricants, odorants, oils, waxes or anti-slip aids, soil repellants, and stain resistant agents.

### g) Water

The one-part storage stable aqueous composition comprises water. According to an embodiment, water up to 100 weight % may be included. According to certain embodiments, the storage-stable composition may be further diluted with more water prior to use. For example, about 5, 10, 15, 20, 25, 50, 60, 70, 80, 90, 100 or 200 weight % of additional water may be added to the aqueous storage stable one-part composition prior to applying the composition to a substrate.

### Applications for the Aqueous Coating Composition

A coated substrate, comprising the aqueous composition as a dried layer on at least one surface of the substrate is provided. The substrate comprises, consists of, or consists essentially of a cementitious or masonry substrate such as at least one of concrete, cement, asphalt, masonry, metals, alloys of metals, metalloids, ceramic, porcelain, granite, silica, or combinations thereof.

A method of coating a substrate is provided. The method comprises, consists of or consist essentially of applying an aqueous coating composition to the substrate. The substrate comprises, consists of, or consists essentially of at least one of concrete, cement, asphalt, masonry, metals, alloys of metals, metalloids, ceramic, porcelain, granite, silica, or combinations thereof.

A coated substrate, including the present one-part composition as a dried layer on at least one surface of the substrate is provided. The substrate may be at least one of concrete, cement, asphalt, masonry, metals, alloys of metals, metalloids, ceramic, porcelain, granite, silica, brick, building stone, such as marble, granite, or limestone, cast stone, concrete block, glass block, adobe or combinations thereof. According to an embodiment, the substrate does not subject to special surface preparation prior to applying the inventive one-part composition. By special surface preparation, it is meant surface preparations such as sand-blasting, power washing with high pressure water, acid etching, or other forms of surface preparations as are known and used in the art to improve adhesion of a coating to a surface, in particular a concrete surface or inorganic substrate surface.

The pigmented aqueous coating may be applied to cured (i.e. hydrated or partially hydrated or hardened or partially hardened) cementitious substrates or may be applied to uncured (i.e., not yet hydrated or not yet hardened) cementitious substrates.

The cementitious substrate as used herein is a substrate that comprises, consists of or consists essentially of a hydraulic cement, since non-hydraulic cements cannot be hardened (cured) when exposed to water. The most commonly used hydraulic cement is Portland cement, and these hydraulic cements have the ability to set and harden under water. The primary curing mechanism for cementitious substrates, i.e. substrates comprising, consisting of or consisting essentially of cement is hydration of the cement binder. In certain embodiments, the cement in the cementitious coating composition is or comprises Portland cement.

Suitable hydraulic cements include all such chemical combinations of lime, silica, and alumina, or of lime and magnesia, silica, and alumina and iron oxide (for example, magnesia may replace part of the lime; and iron oxide may replace part of the alumina), as are commonly known as hydraulic natural cements. Hydraulic natural cements include grappier cements, pozzolan cements, natural cements, Portland cements, white cements and aluminous cements. Pozzolan cements include slag cements made from slaked lime and granulated blast furnace slag. In some embodiments, the cement is or comprises a calcium aluminate cement, also known as high alumina cement. In some embodiments, Portland cement is preferred for its superior strength among the natural cements. In addition to ordinary construction grades of Portland cement or other hydraulic natural cements, modified natural cements and Portland cements, such as high-early strength cement, heat-resistant cement, and slow-setting cement can be used as the substrate in the present invention. Among Portland cements, any of the ASTM types I, II, III, IV, or V can be used. The term, “gray cement” as used herein refers to ordinary Portland cement. The term, “white cement” refers to white Portland cement. Portland cement can be any of the types defined in ASTM C 150, which details the types of Portland cements. Alternatively or in addition, the cements as described in ASTM C 1157 may also be used. “Masonry substrates” as used herein means inorganic substrates such as concrete, brick, building stone (e.g., marble, granite, and limestone), cast stone, concrete block, glass block, or adobe. Typically, these substrates are formed from individual units of these substances, which may be bound together by mortar. As is known in the art, mortar is itself a cementitious substrate since it is a mixture of cement, lime and sand used for laying concrete block and bricks, for example.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the light-curable compositions, composite materials prepared therefrom and methods for making and using such light-curable compositions described herein. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Gloss Measurement of Coating Composition Applied to Leneta Panels:

The coating compositions were applied onto Leneta panels (Form 1B—PENOPAC) using a 3-mil bird bar, followed by 24 hours of drying under ambient (25° C., 50% relative humidity) temperature. The 20/60/85 degree gloss of the dried coating composition surface on the sealed and unsealed panels were evaluated using a Byk-Gardner 4563 Micro-Tri-Gloss Meter.

### Gloss Measurement of Coating Compositions Applied to Concrete Pavers:

The coating compositions were applied onto concrete pavers at approximately 400 square feet per gallon of the coating composition. After 4 hours of drying, a second film of the coating composition was applied using the same method, followed by 24 hours of drying under ambient temperature (25° C., 50% relative humidity). The 20/60/85 degree gloss of paint surface was evaluated using a Byk-Gardner 4563 Micro-Tri-Gloss Meter.

### Dirt Pick Up Resistance Measurements:

The coating compositions were applied onto concrete pavers as described above, followed by drying for 7 days under ambient temperature (25° ° C., 50% relative humidity). A red iron oxide slurry was then applied onto the dried coating compositions and allowed to dry for two hours. Afterwards, the stains were washed off using a sponge with soapy water, followed by drying at 25° C., 50% relative humidity for 24 hours. A Color-guide 6805 colorimeter (BYK Gardner) was used to record L, a, b values in the CIE Lab color space. The values of ΔE denoting color change due to staining, and after the rinsing and scrubbing steps were calculated from changes of L, a, and b values, denoted as ΔE.

### Adhesion Test:

The coating compositions were applied onto concrete pavers as described above. Adhesion performance was measured using a crosshatch tape pull off test based on ASTM D3359B. For dry adhesion test, the dried coating films were crosshatched using a sharp blade to produce a 5×5 grid, followed by applying adhesion tape to each of the films. To ensure good contact with films, tape was rubbed firmly with a tongue depressor. The tape was then immediately pulled off with a constant force at a 180° angle. For wet adhesion test, dried coating films were prepared and cross-hatched following the same procedure described above for the dry adhesion test, except that a piece of paper towel was wet by water droplets and then applied onto the crosshatched area. Afterwards, the wet paper towel was removed and the surface of the dried coating film was blot dried. The adhesion test was performed using the same procedure described above for the dry adhesion test.

### Latex Synthesis (Emulsified Polymeric Binder a))

Latex 1 was prepared by charging 590.2 parts of deionized water and 4.6 parts of Encor® 9710 seed (40% active) latexes (Arkema) into a reactor equipped with a stirrer, reflux condensers, thermocouples, and stainless steel feed lines. After the reactor was heated to 90° C., 0.5 parts of ammonium persulfate in 9.7 parts of water were added into the reactor. The monomer mixture consisting of 511.7 parts of butyl acrylate (BA), 496.4 parts of styrene (STY), 10.3 parts of acrylic acid (AA) was then fed continuously to the reactor over 200 minutes. During the monomer feed, a solution of 11.4 parts of Dowfax® 2Al (anionic surfactant) (45%) and 17.0 parts of acrylamide (30%) in 90.4 parts of water was fed into the reactor over 180 minutes separately. In addition, 4.6 parts of ammonium persulfate in 73.4 parts of water were fed into the reactor over 210 min separately. At the end of monomer feed, 0.2 parts of DREWPLUS® L-131 (foam control agent, Ashland) in 34.4 parts of water was added into the reactor. To reduce the residual monomer concentrations, 6.1 parts of tertiary-butyl hydroperoxide (tBHP, 70% active) and 4.2 parts of sodium hydroxymethane sulfinic acid were fed over 45 minutes at 80° C. The final pH of the latex was adjusted to 9.0 using ammonium hydroxide. The final latex has solids content of 51%, a volume average particle size of 215 nm and Brookfield viscosity below 500 centipoise. The minimum film formation temperature (MFFT) of Latex 1 was 16° C. MFFT of the latex polymer was analyzed on a rectangular temperature gradient bar. The MFFT was determined at the point where the latex formed a clear and uncracked dry film.

### Hybrid Resin Preparation

206.5 parts of Latex 1 and 10 parts of water were mixed under stirring, followed by adding 86.3 parts of KASIL 1 (potassium silicate, 29.1% solids, PQ corporation). Afterwards, 7.5 parts of Silres BS16 (potassium methyl siliconate, 34% active, Wacker Chemie) was added into the mixture, followed by adding 10 parts of water to finalize the preparation of the coating composition. The resin composition had a solids level of 42%, a volume average particle size of 215 nm and Brookfield viscosity below 500 centipoise. The minimum film formation temperature of the coating composition was 14° C.

TABLE 1
Coating compositions of Examples

| | | | |
|---|---|---|---|
| | Inventive | Inventive | Comparative |
| | Example 1 | Example 2 | Example 1 |
| Ingredients | Parts (wt) | Parts (wt) | Parts (wt) |

Grind

| | | | |
|---|---|---|---|
| Water | 188.7 | 188.7 | 188.7 |
| Coadis ™ 123K (dispersant) | 2.5 | 2.5 | 2.5 |
| Natrosol 250 HBR (thickener) | 2.5 | 2.5 | 2.5 |
| NaOH [10% solution] | 2 | 2 | 2 |
| BYK-024 (defoamer) | 3 | 3 | 3 |
| Ti-Pure ™ R-706 (TiO₂; filler) | 180 | 180 | 180 |
| Dextrol ™ OC-50 (surfactant) | 4 | 4 | 4 |
| Individual Letdown | | | |
| Latex 1 (51% solids) | 388.4 | 0 | 388.4 |
| KASIL 1 (potassium | 166.5 | 0 | 166.5 |
| silicate, 29.1% solids) | | | |
| Silres BS16 (potassium methyl | 16.7 | 0 | 0 |
| siliconate, 34% active) | | | |
| Hybrid Resin (contains latex, | 0 | 608.3 | 0 |
| silicate and siliconate) | | | |
| Texanol ™ coalescent | 15.8 | 17.9 | 15.8 |
| Water | 48.8 | 16.1 | 60.7 |
| Latex polymer weight percentage | 19.44% | 19.53% | 19.53% |
| Silicate weight percentage | 4.76% | 4.65% | 4.78% |
| Siliconate weight percentage | 0.56% | 0.47% | 0.00% |

The pigmented coating compositions Inventive Example 1, Inventive Example 2, and Comparative Example 1 were prepared according to Table 1. The PVC of Examples 1 and 2 was 17%. The gloss development of these coating compositions was evaluated on concrete pavers, sealed Leneta panels, and unsealed Leneta panels. As shown in Table 2, both Inventive Example 1 (potassium methyl siliconate added during paint preparation) and Inventive Example 2 (potassium methyl siliconate included in the hybrid resin preparation) showed greater gloss development than Comparative Example 1 (absence of potassium methyl siliconate) on all the tested substrates. Therefore, we surprisingly found that siliconate was able to improve the gloss of the hybrid paint that contained both latex and silicate.

TABLE 2
Gloss* of dried coatings

| | | | |
|---|---|---|---|
| | Inventive | Inventive | Comparative |
| Sample: | Example 1 | Example 2 | Example 1 |

Gloss measured on dried coating
applied to concrete substrate

| | | | |
|---|---|---|---|
| 20° gloss | 6.5 | 17.9 | 1.9 |
| 60° gloss | 43.0 | 64.1 | 11.2 |

Gloss measured on dried coating
composition applied to unsealed Leneta panel

| | | | |
|---|---|---|---|
| 20° gloss | 2.7 | 3.0 | 1.5 |
| 60° gloss | 29.2 | 30.6 | 3.9 |

Gloss measured on dried coating
composition applied to sealed Leneta panel

| | | | |
|---|---|---|---|
| 20° gloss | 3.1 | 5.1 | 1.4 |
| 60° gloss | 11.4 | 39.1 | 3.6 |

*Higher is better

As shown in the FIGURE, all the samples showed good adhesion performance on the concrete, as evidenced by the minimal coating removal after crosshatch tape pull off test (ASTM D3359B). The dirt pick up resistance test revealed that both Inventive Example 1 (potassium methyl siliconate added during the coating composition preparation) and Inventive Example 2 (potassium methyl siliconate included in the hybrid resin) showed greater dirt pick up resistance compared to the Comparative Example 1 (not including siliconate), as evidenced by the smaller color change observed for Inventive Example 1 (ΔE=3.72) and Example 2 (ΔE=3.32) compared to Comparative Example 1 (ΔE=10.27) after the dirt pickup resistance test. Therefore, we surprisingly found that siliconate was able to improve the dirt pickup resistance of the hybrid paint that contained both latex and silicate.

1. An aqueous composition comprising by weight %, based on the total wet weight of the composition:
a) 5-50 weight % of at least one emulsified polymeric binder;
b) 2-10 weight % of at least one water-soluble silicate;
c) 0.01-5 weight % of at least one alkyl siliconate;
d) at least one pigment,
e) optionally at least one filler;
f) optionally at least one additive;
g) water;
wherein a pigment volume concentration (PVC) of the aqueous composition is 40 weight % or less;
wherein the PVC is defined as:
$$\frac{dry volume of ( pigment + filler )}{dry volume of ( pigment + filler + water soluble silicate + polymeric binder )} \times 100.$$

2. The aqueous composition of claim 1, wherein the composition is a one-part composition.

3. The aqueous composition of claim 1, comprising at least about 5-about 40 weight % of the pigment.

4. The aqueous composition of claim 1, wherein the water-soluble silicate and the alkyl siliconate together comprise 4 weight % or more of the total weight of the aqueous composition.

5. The aqueous composition of claim 1, wherein the at least one silicate b) comprises at least one of inorganic silicate salts, sodium silicate, potassium silicate, lithium silicate, rubidium silicate, ammonium silicate, orthosilicates, or a mixture thereof.

6. The aqueous composition of claim 1, wherein the at least one alkyl siliconate c) conforms to Formula (I): 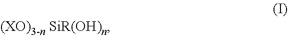
wherein X is an alkali metal; n is 0, 1, or 2; and R is an alkyl or aryl group.

7. The aqueous composition of claim 6, wherein X comprises at least one of sodium, potassium, lithium, rubidium, cesium, or combinations thereof.

8. The aqueous composition of claim 6, wherein R comprises a C1-C8 alkyl group or an aryl group.

9. The aqueous composition of claim 6, wherein R comprises methyl, ethyl, n-propyl, iso-propyl, n-butyl, iso-butyl, tert-butyl, n-pentyl, iso-pentyl, tert-pentyl, neopentyl, phenyl, aryl, cyclohexyl.

10. The aqueous composition of claim 6, wherein R is methyl, X is potassium and n is 0.

11. The aqueous composition of claim 1, wherein the binder a) comprises, as a polymerized monomer, from 0.1-99.9 weight % of alkyl (meth)acrylate based on the dry weight of the binder a).

12. The aqueous composition of claim 1, wherein the emulsified polymeric binder a) comprises, as a polymerized monomer, from 0 to 10 weight % of (meth)acrylamide or derivatives thereof based on the dry weight of the binder a).

13. The aqueous composition of claim 1, wherein the binder a) comprises, as a polymerized monomer, from 0 to 10 weight % of (meth)acrylic acid based on the dry weight of the binder a).

14. The aqueous composition of claim 1, wherein the binder a) comprises, as a polymerized monomer, from 0-90 weight % of vinyl aromatic monomer based on the dry weight of the binder a).

15. The aqueous composition of claim 1, wherein the binder a) further comprises, as a polymerized monomer, at least one crosslinkable co-monomer comprising two or more sites of ethylenic unsaturation.

16. The aqueous composition of claim 1, wherein the binder a) further comprises at least one separate crosslinking agent, and wherein the binder a) further comprises, as a polymerized monomer, at least one crosslinkable co-monomer comprising an ethylenic unsaturation and at least one moiety capable of reacting with the separate crosslinking agent.

17. The aqueous composition of claim 1, wherein the binder a) further comprises, as a polymerized monomer, at least one monomer comprising at least one of vinyl monomer, mono-ethylenically unsaturated carboxylic acid monomer, phosphorous-containing monomer, sulfur-containing monomer, silane co-monomers, and mixtures thereof.

18. The aqueous composition of claim 1 comprising at least one additive.

19. A coated substrate, comprising the one-part aqueous composition of claim 1 as a dried layer on at least one surface of the substrate, wherein the substrate comprises at least one of concrete, cement, asphalt, masonry, metals, alloys of metals, metalloids, ceramic, porcelain, granite, silica, or combinations thereof.

20. A method of coating a substrate, the method comprising applying an aqueous coating composition comprising the composition of claim 1 to the substrate, wherein the substrate comprises at least one of concrete, cement, asphalt, masonry, metals, alloys of metals, metalloids, ceramic, porcelain, granite, silica, or combinations thereof.
